(19) United States
(12) Patent Application Publication
(10) Pub. No.: US 2015/0381336 A1
(43) Pub. Date: Dec. 31, 2015

(54) MULTI-USER AGGREGATION OVER FREQUENCY

(71) Applicant: Intel IP Corporation, Santa Clara, CA (US)

(72) Inventors: Po-Kai Huang, West Lafayette, IN (US); Robert J. Stacey, Portland, OR (US); Assaf Kasher, Haifa (IL)

(21) Appl. No.: 14/318,902

(22) Filed: Jun. 30, 2014

(51) Int. Cl. H04L 5/26; H04W 72/04

(52) U.S. Cl. CPC H04L 5/26; H04W 72/0433; H04W 72/044

(57) ABSTRACT

Embodiments describe mechanisms for an Access Point (AP) to aggregate multiple devices (e.g., stations (STA)) across frequency during a single time period. STAs will be considered for frequency aggregation only if they have a measured SNR at the AP below a threshold. Methods are described that select STAs for aggregation based on associated SNR and other criteria and then assign frequency slots to the selected STAs. Selection for aggregation and assignment to frequency slots can also be balanced across time, so that different STAs are selected for aggregation over time. Mechanisms are also described that increase the opportunities for frequency aggregation.

### TECHNICAL FIELD

Embodiments pertain to wireless communications. More particularly, some embodiments relate to aggregation of multiple users in the frequency domain for wireless communications.

### BACKGROUND

Demand for data carrying capacity of wireless networks of all types is increasing. For example, in an 802.11 type network, an access point (AP) may communicate with multiple stations (STAs). Mechanisms to increase the overall data carrying capacity in such situations are ever more important to proper functioning of wireless networks.

### BRIEF DESCRIPTION OF THE DRAWINGS

FIG. 1 illustrates an example architecture showing multiple stations communicating with a single access point.

FIG. 2 illustrates communications between multiple stations and an access point using different bandwidth allocation schemes.

FIG. 3 illustrates an example chart showing efficiency of communication as a function of signal to bandwidth-noise level.

FIG. 4 illustrates example communications for multiple stations using frequency aggregation.

FIG. 5 illustrates an example flow diagram for a method to select devices for frequency aggregation.

FIG. 6 illustrates example flow diagrams for different methods to select devices for frequency aggregation.

FIG. 7 illustrates an example flow diagram to allocate frequency slots to selected devices.

FIG. 8 illustrates a diagram of allocating frequency slots to selected devices.

FIG. 9 illustrates a diagram of a device providing opportunity for frequency allocation of other devices.

FIG. 10 illustrates a system block diagram of a wireless device, according to some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Various modifications to the embodiments will be readily apparent to those skilled in the art, and the generic principles defined herein may be applied to other embodiments and applications without departing from the scope of the disclosure. Moreover, in the following description, numerous details are set forth for the purpose of explanation. However, one of ordinary skill in the art will realize that embodiments of the disclosure may be practiced without the use of these specific details. In other instances, well-known structures and processes are not shown in block diagram form in order to not obscure the description of the embodiments with extraneous detail. Thus, the present disclosure is not intended to be limited to the embodiments shown, but is to be accorded the widest scope consistent with the principles and features disclosed herein.

One possible way to increase the data carrying capacity of wireless networks is to aggregate devices across frequency, where the available bandwidth is divided into multiple frequency slots and multiple devices transmit on a different frequency slot during the same time slot. Mutual interference, where the data transmitted by one device causes interference in adjacent frequency slots can limit the effectiveness of such an approach. In this disclosure, a station or device will generally be used to refer to the entity that is sending/receiving information to/from an access point (AP). An AP is an entity (e.g., device, etc.) that allows stations (e.g., wireless devices) to connect to a wired network using Wi-Fi or related standards. In some embodiments a device can act as both a station and an access point at different times.

Mechanisms are described in this disclosure to identify criteria that define when aggregation across frequency will result in efficiency gains. Using such criteria, an access point (AP) selects whether to aggregate devices across frequency. If aggregation across frequency is selected, the access point then identifies which devices should be aggregated based on different criteria and allocates frequency slots to the selected devices using an allocation method. Various protocol variations are described which can increase efficiency.

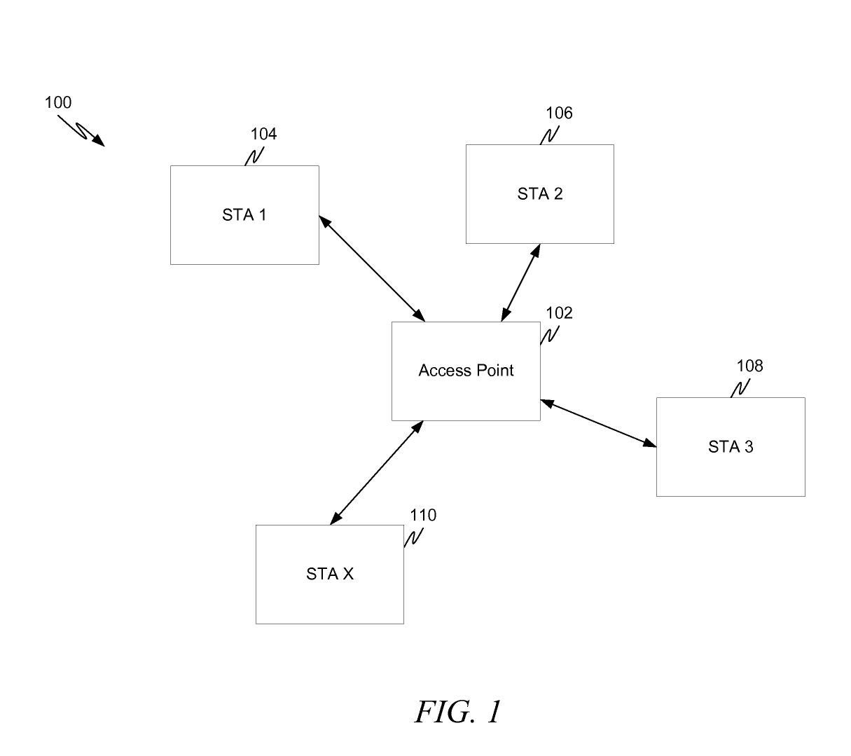

FIG. 1 illustrates an example architecture 100 showing multiple stations (e.g., 104, 106, 108 and 110) communicating with a single access point 102. In this situation, the various stations 104, 106, 108, and 110 will contend with each other for bandwidth and time to transmit/receive data to/from the access point 102. The protocols and standards of the wireless network will determine how the contentions are resolved and which stations receive the bandwidth and time to transmit at what time slot.

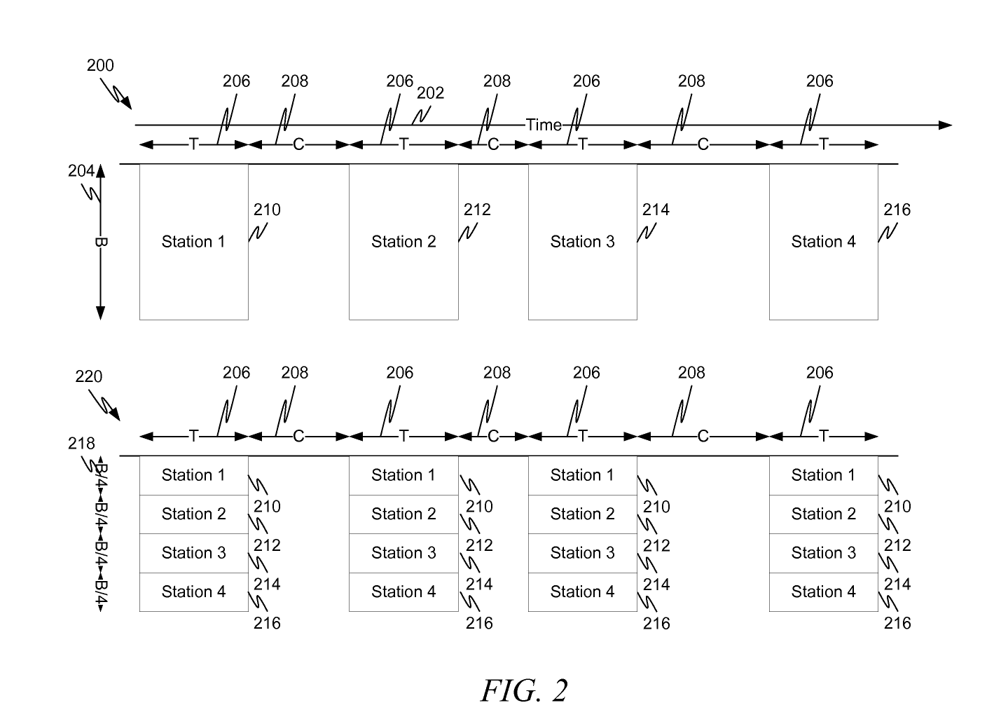

FIG. 2 illustrates a typical communication between multiple stations 210, 212, 214 and 216 generally as 200. Stations 210, 212, 214 and 216 generally have a time slot T 206 that they transmit using the entire available bandwidth B 204 that is usually allocated to the device. There can be a contention period C 208 between time slots T 206 where stations 210, 212, 214 and 216 are contending for the right to transmit.

As shown below, under certain conditions, the scheme shown generally as 220 can be more efficient in terms of bits/s/Hz of bandwidth. In this scheme, the bandwidth B 204 normally allocated to a station is divided into frequency slots. Thus, if the bandwidth is B and the minimum frequency unit is Z, then the number of available frequency slots is X=B/Z. Taking the example of FIG. 2 where X=4, then each frequency slot is B/4 wide as shown by 218. If one frequency slot is allocated to each of the four stations 210, 212, 214 and 216, then all can transmit on the same time slot T 206 as illustrated.

Conditions where efficiency gains (increase in terms of bits/s/Hz of bandwidth) of the scheme 220 over the scheme 200 depend on signal to noise ratio and allocated bandwidth per slot. Efficiency, E (bits/s/Hz) is defined as:

$$E = \frac{bits transmitted}{transmission duration * Bandwidth} = \frac{data rate}{Bandwidth}$$

If we define the efficiency of the scheme 200 as E₁ and the efficiency of the scheme 220 as E₂, and assume that all devices have the same signal strength S, then:

$${E}_{1} = log ( 1 + \frac{S}{BN} ) and {E}_{2} = log ( 1 + \frac{S}{BN / 4 + I} )$$

where N is the spectral noise density and I is the interference from an adjacent band. If we assume that the scaled spectral mask for any transmission band, B_{T}, is flat (e.g., no loss) across the band and model the roll-off of the power in bands outside B_{T} with a simplified mask (e.g., −20 dB relative at B_{T}/2 from the center frequency, −28 dB relative at the next B_{T}/2 and −45 dB relative at the next B_{T}/2), then it can be shown that the efficiency E₂ can be written as:

$${E}_{2} = log ( 1 + \frac{S / BN}{0.25 + 0.005 * α S / BN} )$$

Where α is a factor between 0 and 1 that accounts for the interference from adjacent frequency slots. When α=0, there is no interference from adjacent bands and α=1 represents the worst-case performance estimate. In reality, α will be smaller because the side lobe of a subcarrier decays around 5 dB for every 312.5 KHz in a typical receiver. If the access point can accurately track each subcarrier, we would expect a α≈0.1 in practice.

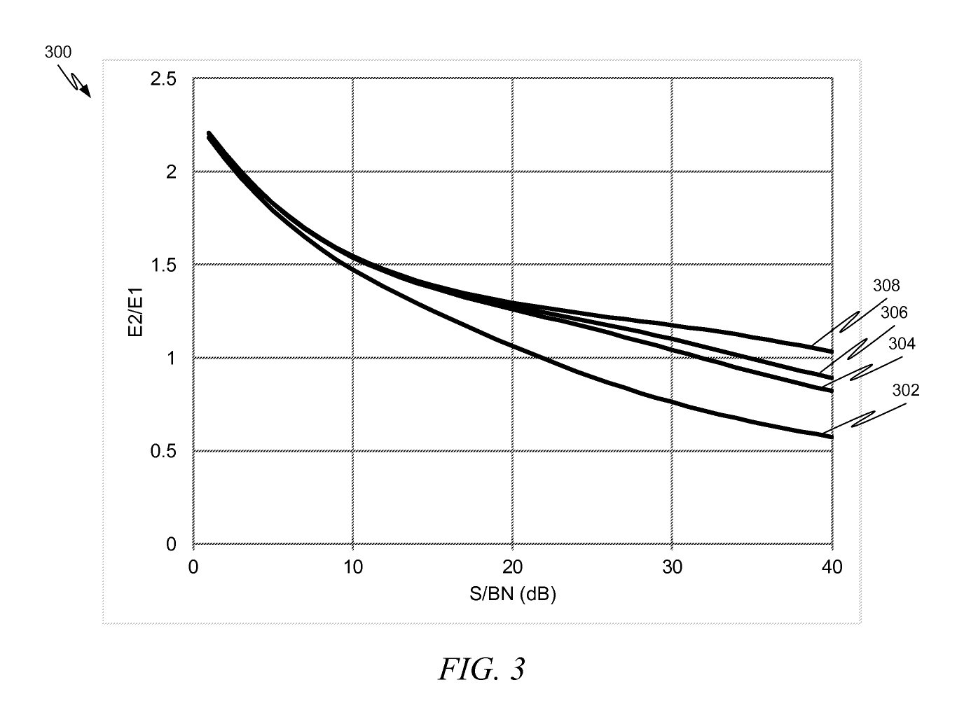

FIG. 3 illustrates an example chart 300 showing efficiency (E₂/E₁) of communication as a function of signal to bandwidth-noise level. The curve labeled 302 is for α=1. The curve labeled 304 is for α=0.1. The curve labeled 306 is for α=0.05 and the curve labeled 308 is for α=0.01. For areas of the curves above 1, efficiencies can be realized by frequency aggregation of multiple stations. The gains become greater as the signal to bandwidth-noise ratio goes down. If we just consider a normalized bandwidth, then the gains become greater as the signal to noise ratio (SNR) goes down. On a conceptual level, this is because as SNR increases, the mutual interference between bands also increases. Thus embodiments herein select a threshold for SNR above which frequency aggregation will not be considered. Below the threshold frequency aggregation will be considered. Such a threshold is typically chosen to lie between about 20 dB and about 30 dB, although values outside of this range may be selected, depending on the characteristics of the receivers. For receivers that can closely track subcarriers, that have good modulation and coding schemes between frequency channels, or that have other mechanisms that reduce inter-frequency slot interference, higher thresholds can be selected. For receives that have higher inter-frequency slot interference, lower thresholds can be selected. One note about the use of Signal to Noise Ration (SNR) and/or Signal to Noise plus Interference Ratio (SNIR) in this disclosure. In this disclosure SNR is meant to encompass SNIR. SNR is often used in this disclosure to describe a measured quantity (for example as when a received signal from a given station has a particular measured and/or associated SNR or SNIR). Such a measurement necessarily includes both noise and any interference that is present. If interference is not present, then the measurement would be strictly measuring signal to noise ratio. Thus, SNR and SNIR may effectively be interchangeable in this disclosure, as the receiver may not know if it is measuring strictly noise, or noise plus interference. In this disclosure SNR is used to generally represent SNR and/or SNIR unless it is important to refer to SNIR specifically (such as in deriving specific results). Additionally, under conditions where the noise and/or interference are effectively constant (e.g., not varying or slowly varying over the relevant time period), a measured signal level can be used as well. Under the conditions of constant noise/interference, a higher signal means a higher SNR/SNIR and a lower signal means a lower SNR/SNIR. In this disclosure the term “signal measurement” will be used to mean a measured signal quantity, such as signal level, SNR, SNIR, and so forth that can be used to determine which stations should be aggregated as described below.

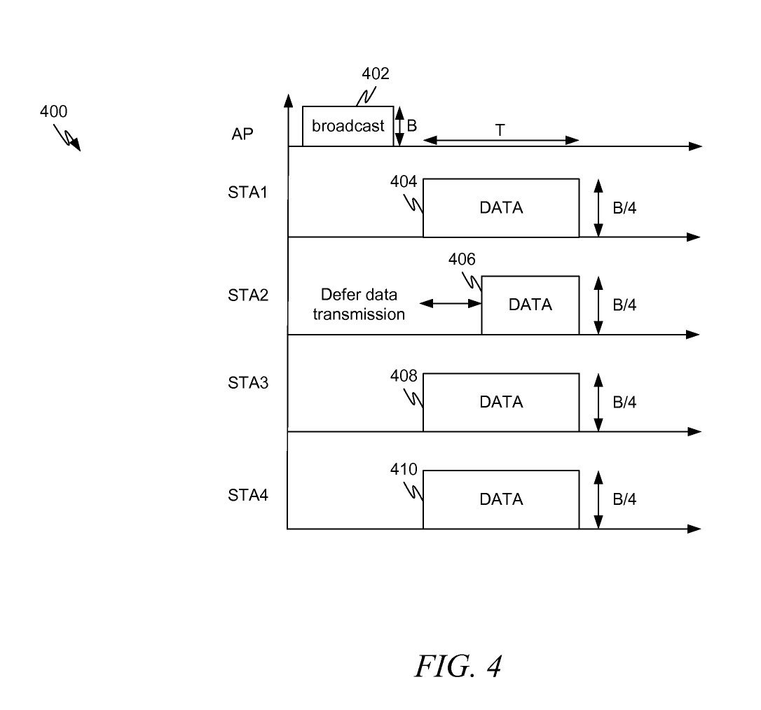

FIG. 4 illustrates example communications 400 for multiple stations using frequency aggregation. 802.11e and 802.11n wireless standards define ways to increase throughput by sending two or more data frames in a single transmission. For example, the standard defines Medium Access Control (MAC) Protocol Data Unit (MPDU) aggregation, sometimes referred to as A-MPDU or AMPDU. It has been shown that such aggregation increases efficiency because the contention overhead will decrease and because the transmission time increases. A-MPDU is combined in some embodiments with frequency aggregation. As illustrated in FIG. 4, the transmission time T is the same for all aggregated stations. If aggregated stations have varying amounts of data to transmit, some stations may not fill the entire transmit time, T. Thus, in FIG. 4, station 1 has data 404 to transmit, station 2 has data 406 to transmit, station 3 has data 408 to transmit and station 4 has data 410 to transmit. If station 2 data (e.g., 406) does not occupy as much physical time, then should station 2 begin transmitting at the same time as stations 1, 3 and 4, it would finish before the end of the time slot T. However, due to the frequency aggregation, the AP would be unable to transmit an acknowledgement (ACK) because the AP is still receiving data from the other stations. In such situations, a remedy is to delay the data transmission as appropriate so that the data 406 finishes at the same time as the other stations. The AP can then transmit ACKs, as appropriate.

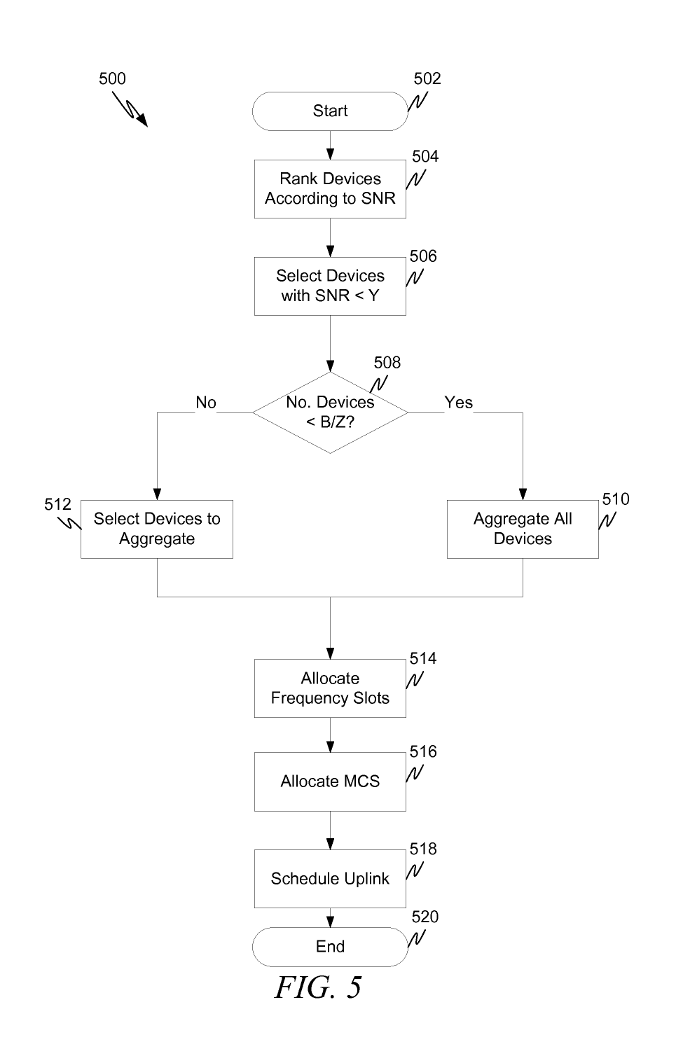

FIG. 5 illustrates an example flow diagram 500 for a method to select devices for frequency aggregation. The method starts at operation 502 and in operation 504 ranks the devices according to their signal measurement as seen by the AP. In this regard, the AP can measure SNR, SNIR, signal level, or other measurements from the transmissions received from the various stations. This optional operation allows the AP to quickly apply determine which stations have a signal measurement above the threshold where they will be considered for aggregation and which stations have a signal measurement below the threshold as indicated in operation 506. However, alternatives may be employed where each station is examined as indicated in operation 506 and those with a signal measurement about the threshold (e.g., Y) can be sorted from those with a signal measurement below the threshold, Y. Different embodiments sort stations with a signal measurement equal to the threshold, Y, into either the group that will be considered or into the group that will not be considered, depending on the embodiment.

At this point, the AP can identify whether to aggregate across frequency or not aggregate across frequency. Reasons to aggregate across frequency would be that multiple stations fall into the category where frequency aggregation will yield gains, and so forth. Reasons to not aggregate across frequency would be things like there are few, if any, stations that would benefit from frequency aggregation, the data that the stations have to transmit is small (and thus frequency aggregation is of less interest), the AP wants to allow a station that will not benefit from aggregation the opportunity to transmit, and so forth. The AP can implement a module and/or a method to weigh the various factors and determine whether to apply frequency aggregation or not. The module and/or method can weigh the various factors and implement rules to identify whether to apply frequency aggregation. An operation where the AP specifically determines whether to apply frequency aggregation or not is not specifically illustrated in FIG. 5, but is included in some embodiments.

Operation 508 identifies the number of devices with appropriate associated signal measurement and compares it to the number of frequency slots available, X. As identified above, X=B/Z where B is the bandwidth and Z is the frequency slot size. If the number of devices with appropriate signal measurement is less than the number frequency slots, then the “yes” branch is taken and the AP selects all devices for aggregation as indicated by operation 510.

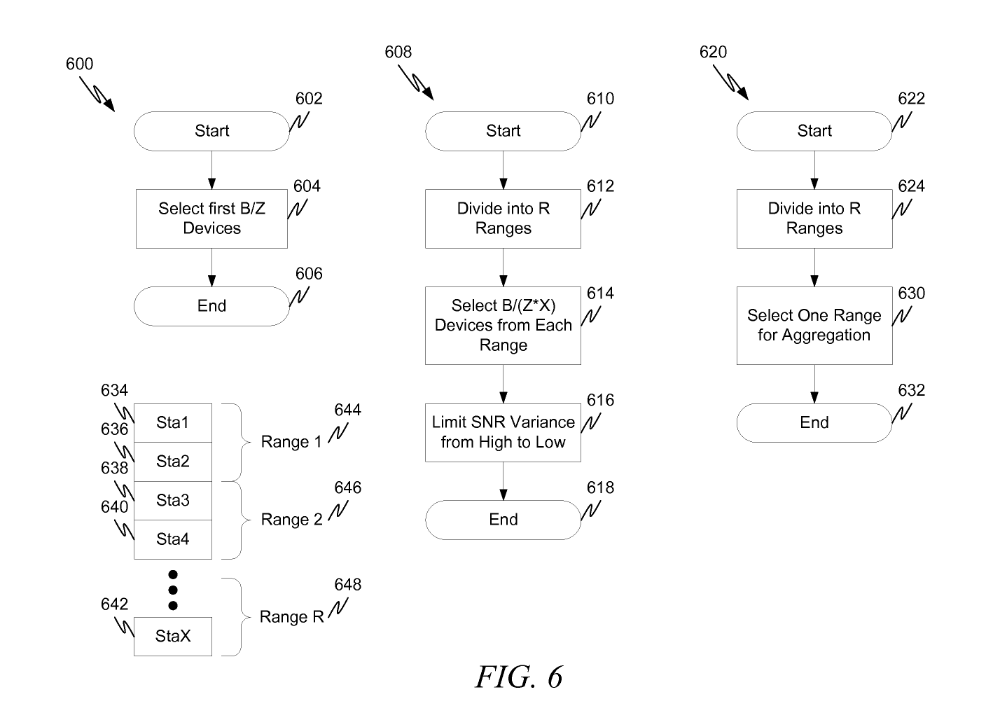

If the number of devices that are considered for aggregation exceeds the number of frequency slots, then a method to select a subset of the appropriate devices is used as indicated in operation 512. Representative methods are discussed in conjunction with FIG. 6.

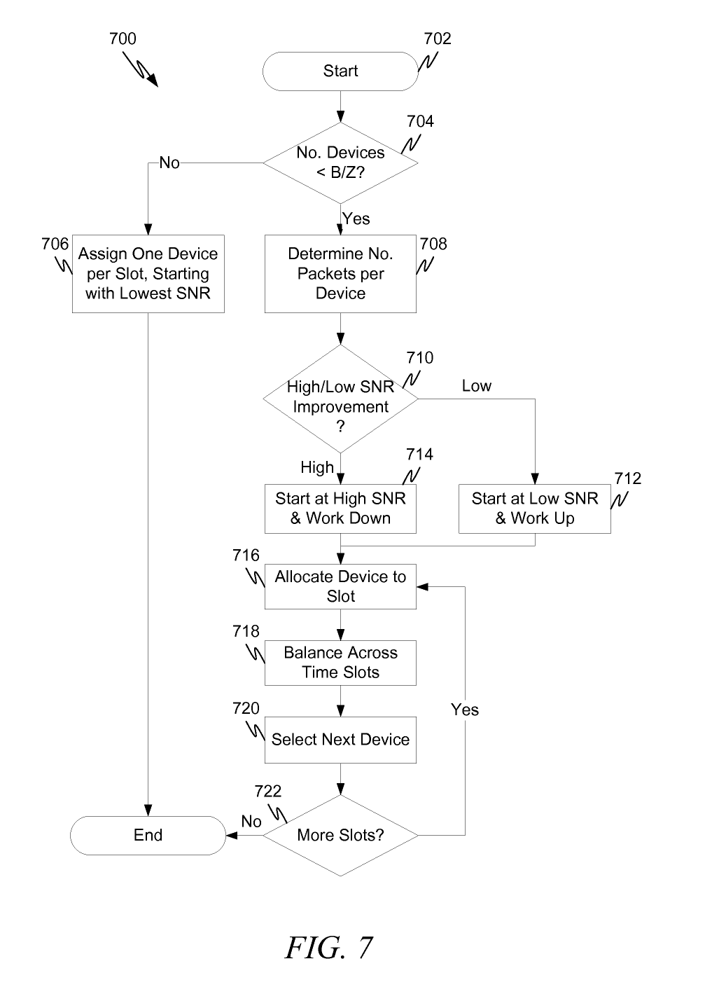

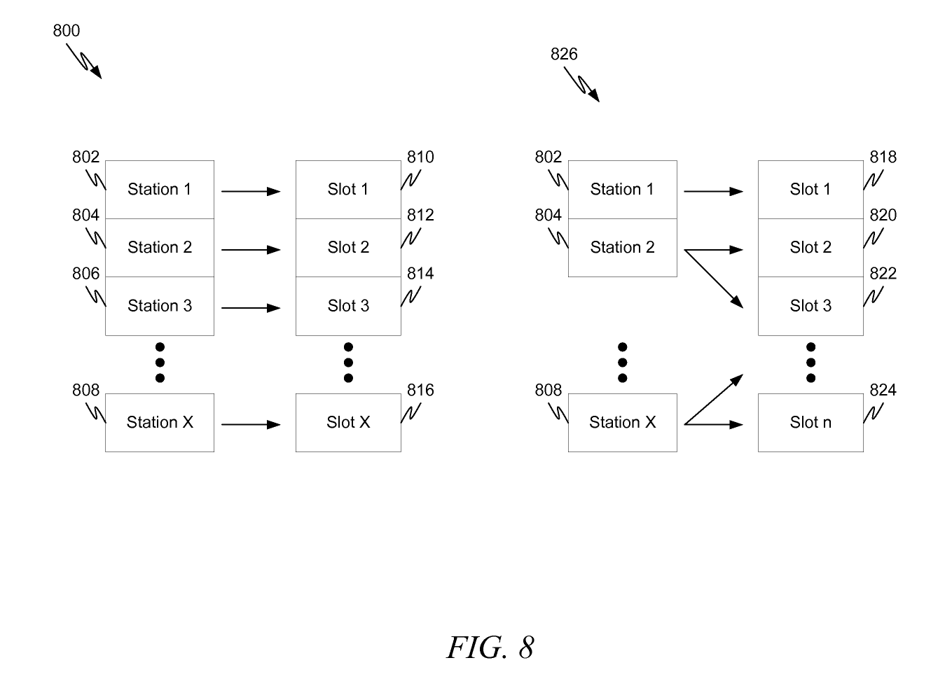

Once the devices that will be allocated frequency slots are identified, then the AP allocates frequency slot(s) to the selected devices as indicated in operation 514. A discussion of frequency slot allocation is included below in conjunction with FIGS. 7 and 8.

In certain embodiments, the AP also selects appropriate modulation and coding schemes (MCS) to assign to the different stations as indicated in operation 516. In some embodiments, the AP identifies MCS for all the selected stations. In other embodiments, the AP identifies MCS for some fraction of the selected stations. The MCS can be selected based on some measurement of the signal (e.g., signal to interference plus noise ratio (SINR), SNR, or signal level) and/or based on the data available to a given station. Each of these factors (e.g., signal measurement and adjusting MCS based on data to be transmitted) is discussed below.

As the AP has estimates of the signal strength and bandwidth assigned to device, i, the AP can estimate the interference I from the adjacent band(s). For example, the signal to interference plus noise ratio (SINR) can be predicted by:

$${SNIR}_{i} = \frac{{S}_{i}}{( {B}_{i} * N + I )}$$

The SNIR can suggest a suitable modulation and coding scheme for the station, depending on which version of the 802.11 standard a station implements. For example, stations implementing 802.11n standard have 32 different MCS values that define the number of spatial streams, the modulation type, and the coding rate. Given these values and channel bandwidth, the theoretical data throughput for a given MCS value can be calculated. Stations implementing 802.11ac standard have different MCS values that define different values for modulation type and coding rate for a given spatial stream. These parameters, along with the estimated SNIR can be to determine which MCS value would be better for frequency aggregation. For a given MCS, there is a mapping between SNIR and packet error rate. To select an MCS for a fixed SNIR, some embodiments select the highest MCS (e.g., MCS with the largest data throughput) with a given error rate, such as 10%. Additionally, or alternatively, simulation and/or field measurements are used in some embodiments to determine the MCS to select for a given SNIR.

Since each aggregated station will have the same data transmission time, it is possible to match an MCS to the data that a station has to transmit. Thus, rather than delaying transmission as indicated in FIG. 4 so that all stations end at the same time, MCS can be adjusted so more or less data is transmitted in the time slot, T.

Different embodiments can either 1) not adjust MCS, 2) adjust MCS for some or all of the stations based on estimated SNIR, SNR, signal level or other signal measurement 3) adjust MCS for some or all of the stations based on the data a station has to transmit, and/or 4) adjust MCS based on a combination of a signal measurement (e.g., SNIR, SNR, signal level, etc.) and the data a station has to transmit, and/or combinations thereof.

In operation 518 the AP schedules the uplink according to the implemented standard and the method ends at operation 520.

FIG. 6 illustrates example flow diagrams for different methods (e.g., 600, 608, 620) to select devices for frequency aggregation (e.g., operation 512 of FIG. 5). The simplest method is illustrated by 600. In this method, the AP selects the first X=B/Z devices. As explained above, B is the bandwidth to be allocated, Z is the frequency slot size, and X is the number of frequency slots. The allocation can start either from the device having the highest signal measurement in the subgroup or can start from the device having the lowest signal measurement in the subgroup. Other embodiments can start somewhere else (e.g., with a device in the list that does not have the highest or lowest signal measurement). Once a starting point is selected, the next X devices are selected. This is indicated by operation 604.

The advantage of this method is that it is simple and straight forward to implement when the list of devices are sorted by associated signal measurement. Additionally, selecting X consecutive devices tends to keep the variance between the highest and lowest associated signal measurement to a minimum. This characteristic is good because a signal with a high signal measurement will tend not be assigned a slot next to a signal with a low signal measurement, where the interference from the signal with a high signal measurement is a problem for the signal with a lower signal measurement. The disadvantage is that unless the starting point is rotated, the same devices will tend to be scheduled for transmission. Additionally, assuming equal transmit power and equal channel characteristics, devices with similar signal measurement tend to be located at a similar distance. If the devices are located in the same area, they may all be blocked by existing transmissions in that area. The result is that no one will transmit on the assigned time slot. On the other hand, if spatial diversity exists in the devices (e.g., they are not all located in the same area), the likelihood that all will be blocked due to a transmission in their area is lower.

A second method is illustrated by 608. In this method, the list of candidate devices (e.g., those devices with an associated signal measurement lower than a threshold, Y) is divided into R ranges as indicated in operation 612. Ranges are illustrated where station 1 634 and station 2 636 are assigned to range 1 644, station 3 638 and station 4 640 are assigned to range 2 646, and so forth until the last station (e.g., station X 642) is assigned, possibly along with other stations, to the final range R 648. Various mechanisms can be used to select the number of ranges, R. In some embodiments, the ranges are selected so that the devices have similar associated signal measurement values. This can be accomplished, for example, by limiting the difference in associated signal measurement values between the first and last member to less than some value. In other words, a range is created such that if the first member has a signal measurement equal to n, the last member has a signal measurement less than or equal to n+threshold. The process can be repeated for any devices that are not assigned to a range. Additionally, or alternatively, the difference between adjacent members of the range can be limited to some value. The number of ranges can also be selected based on the number of devices, and the number of frequency slots that will be assigned. Various embodiments employ various combinations of these mechanisms to divide the candidate devices into R ranges.

Once the devices are divided into R ranges, operation 614 selects B/(Z*R) devices from each range. For example, typical values for B would be 20 MHz or 40 MHz and a typical value for Z would be 5 MHz. If B is 20 MHz. and Z is 5 MHz., and R is 4 then the number of devices selected from each range is 1 (e.g., 20/(5*4)). Therefore, operation 614 would select one device from each range. It is possible that the number of ranges is not equal to the number of slots. Assignment of devices to frequency slots is discussed below.

Frequency aggregation works best if there is not a large difference in associated SNR values between frequency slots. Therefore, some embodiments select devices such that the difference between the highest and lowest associated SNR is less than a given threshold. Additionally, or alternatively, the difference between associated signal measurement for adjacent frequency slots can also be limited to less than a given threshold. Optional operation 616 depicts selecting devices so that the overall difference in associated signal measurement is less than a threshold and/or the slot to slot variation in associated signal measurement is less than a threshold (e.g., the same or a different threshold).

Yet another method is illustrated as 620. In this method, operation 624 divides the devices into R ranges (e.g., the same as operation 612). Thus, the discussion in conjunction with operation 612 above apply here. In this method, however, one or more of the ranges are then selected for aggregation as indicated by operation 630.

In any of these methods (e.g., 600, 608, 620) the actual number of devices selected for slot assignment can account for the data that previously selected members have to transmit. For example, suppose method 620 is used to select devices for slot assignment. When dividing the devices into R ranges, one range had three members and the subsequent range had four. In this example, the number of frequency slots is 5. Thus, the method can select the range with three members, can select the range with four members, or can select some combination of members from both ranges (e.g., select one member from each range until the slots are filled, or select one member from each range with a total selected of less than the number of slots). If some members have more data to transmit than will fit within a time slot, T, they can be assigned multiple frequency slots, as discussed below. Thus, the amount of data to be transmitted can be a factor in determining how many devices to select for frequency allocation.

FIG. 7 illustrates an example flow diagram 700 to allocate frequency slots to selected devices (e.g., operation 514 of FIG. 5). The method begins at operation 702 and first examines the number of selected devices relative to the number of slots to allocate. Assuming there is X=B/Z frequency slots, operation 704 identifies whether there are more frequency slots than devices. If not, then the “no” branch is taken and one device will be assigned to one frequency slot in operation 706. Frequency slots are typically assigned to devices to minimize the variance of associated signal measurement in adjacent slots. Thus, operation 706 typically starts with the device with the highest or lowest associated signal measurement and assigns successive devices (e.g., the next highest/lowest associated signal measurement) to successive slots.

Assigning one device to one frequency slot is illustrated generally in FIG. 8 as 800. In this illustration, station 802 is assigned to slot 810, station 804 is assigned to slot 812, station 806 is assigned to slot 814 and so on until station 808 is assigned to slot 816. The stations (802, 804, 806, 808) are arranged from highest associated signal measurement to lowest associated signal measurement or vice versa to minimize slot to slot signal measurement variation.

Returning to FIG. 7, if the number of devices is less than the number of slots, then the “yes” branch is taken out of operation 704. In this branch, multiple slots can be assigned to a single device based on a variety of factors. For example, if devices have more data than can be transmitted in a single time period, they can be allocated multiple frequency slots. Thus, operation 708 determines how much information each selected device needs to transmit if the information is available. Thus, more slots can be allocated to devices that have more data to transmit, while those with information to transmit (e.g., more packets) than can fit in a single slot can be allocated a single slot. Thus, each device can have a “number of desired slots” metric associated with it.

If the total number of desired slots is greater than the number of slots available to be allocated, then the AP needs to choose which devices will get multiple slots and which will not. Assuming all data is equal priority, then the slots can be assigned in a round robin type manner until all slots are allocated. With this type of method, the “end” of the list that is used to start will likely receive more slots. In other words, if the method starts with the devices with the highest associated signal measurement values, devices with the higher associated signal measurement values will tend to get more slots than those with lower associated signal measurement values. If the method starts with the devices with the lowest associated signal measurement values, those devices with lower associated signal measurement values will tend to get more slots. Thus, operation 710 determines whether to start with the devices with the higher or lower associated signal measurement values.

Selecting whether to start with higher associated signal measurement values or lower associated signal measurement values can be based on a variety of factors. Starting with the lower signal measurement values may give better overall efficiency since a greater number of lower value signal measurement packets will be aggregated than higher value signal measurement packets. As discussed above, this improves efficiency. However, starting with the higher value signal measurement packets may improve overall performance when retransmission of improperly received packets (due to error rates associated with lower signal measurement and so forth) and other such considerations are taken into account.

If the AP decides to start with the high value signal measurement devices and work down, operation 714 is performed. If the system decides to start with low value signal measurement devices and work up, operation 712 is performed. Note that not all embodiments need to implement operations 710, 712, and 714. Different embodiments employ a single methodology of assigning slots starting with the high value signal measurement devices. Other embodiments employ a single methodology of assigning slots starting with the low value signal measurement devices. Others employ the selection methodology described in operation 710, 712 and 714.

Operation 716 assigns the next device in line to a frequency slot.

Operation 718 is optional in that it is implemented in some embodiments but not in others. Operation 718 represents a method to balance slot assignments across time slots. If there are more desired frequency slots than available frequency slots, information about which devices were assigned multiple frequency slots in prior time periods is utilized in some embodiments to balance frequency slot assignments over time so that the same devices aren't always assigned multiple frequency slots at the expense of other devices in each time period. A type of “aging” logic can be applied so that devices that have data to transmit but were not assigned multiple slots in prior time periods have more priority in slot assignment. To extend the concept, various factors such as desired slots, associated signal measurement (and/or equivalently a metric associated with expected efficiency gains if the devices is aggregated), time since last aggregated slot assignment, and so forth can be weighed together to create an ‘assignment priority’ and the slots can be assigned based on assignment priority. Similar balancing across time slots can occur at different levels. For example, in the operations that select devices for frequency slot assignment (e.g., operation 512 of FIG. 5, methods 600, 608, 622 of FIG. 6) can use criteria that balances device selection across time slots so that the same devices are not always selected for transmission and/or aggregation.

Operation 720 selects the next device that still has packets to transmit (e.g., is still desiring a frequency slot). In operation 722, the above process continues (the “yes” branch) until there are no more slots or until there are no more devices to assign to slots (the “no” branch).

FIG. 8 illustrates allocating multiple frequency slots to devices generally as 826. In this aspect of FIG. 8, station 802 is assigned slot 818, station 804 is assigned to both slot 820 and slot 822, and so forth until station 808 is assigned to slot 824 and possibly to one or more other slots (not shown).

The improvements described above are achieved most readily when the AP has the opportunity to transmit and schedule time slots. In a contention based protocol, such as used by 802.11 type devices, the AP can increase the likelihood of transmission by modifying its behaviors to increase the likelihood it will “win” the contention and be able to transmit more frequently. To increase the likelihood of grabbing the medium and aggregating devices across frequency more often, the AP can reduce its minimum window size and/or increase the minimum size of its associated devices. This provides more time for actual data transmission by devices as well as increase the likelihood that the AP will be able to “grab” small time slots for scheduling.

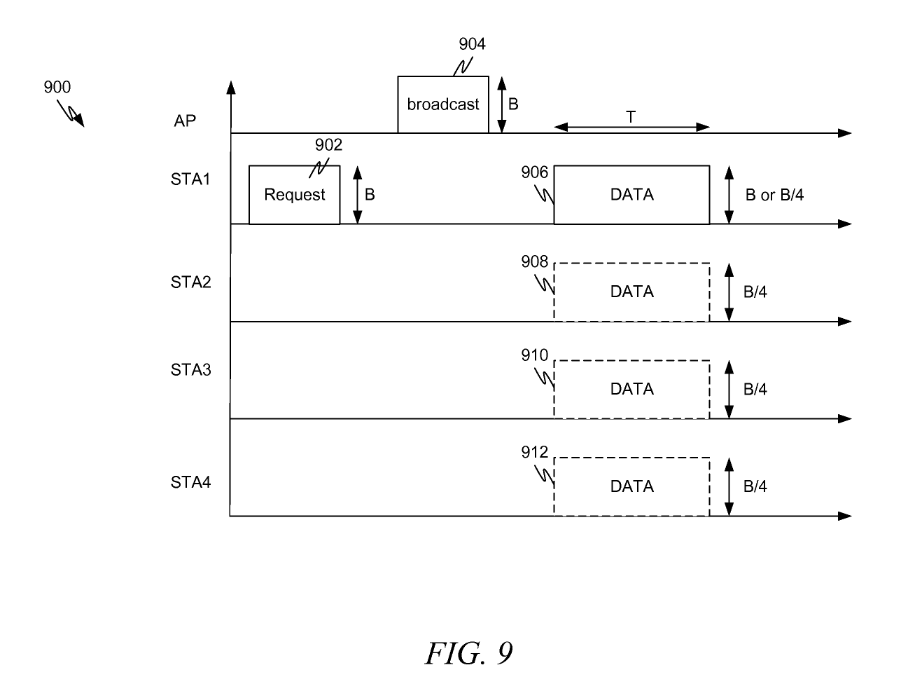

Another improvement that increases the opportunity to aggregate devices is illustrated in FIG. 9. FIG. 9 illustrates a diagram 900 of a device providing opportunity for frequency allocation of other devices. After a device grabs the medium (e.g., STA1 in FIG. 9) and before it sends the data, it first sends a request 902. The AP receives the request 902 and checks the signal measurement of the device (e.g., STA1). If the device has an associated (e.g., measured) signal measurement larger than the threshold Y (e.g., the threshold above which devices will not be considered for aggregation), then there are no performance gains to be had by aggregating other devices with STA1. In this case, the AP replies with a response (e.g., message 904 tailored to let STA1 know to use a full bandwidth broadcast) and STA1 proceeds with its data transmission 906 using the full bandwidth B. The request/response exchange described act as the role of Request To Send (RTS) and Clear to Send (CTS).

On the other hand, if the device has an associated signal measurement smaller than the threshold Y, performance gains are available by aggregating multiple devices with STA1. In this case, the AP can select other devices to aggregate with STA1 based on criteria such as associated signal measurement, packets to send, and so forth. The devices to aggregate and the frequency slots assigned can be selected using methods such as those described above in conjunction with FIGS. 5, 6, 7 and 8. In this case, response 904 is a broadcast message tailored to let STA1 know to transmit over its assigned frequency slot(s) (e.g., data 904 transmitted over bandwidth B/4) as well as letting other devices (e.g., STA2, STA3, STA4) to transmit data during time period T over their assigned frequency slots. Again, the request 902 and response 904 operate as a RTS/CTS exchange.

This technique proves the AP an opportunity to aggregate other devices whenever a RTS/CTS type exchange is made. The technique may also help alleviate the situation where some devices scheduled by the AP are blocked (e.g., through contention) by a hidden devices that the AP cannot/did not detect since the request 902 from STA1 reserves the medium during the time period T so that the devices around STA1 are not blocked for transmission when scheduled by the AP in broadcast 904.

### Example Device Architecture and Machine-Readable Medium

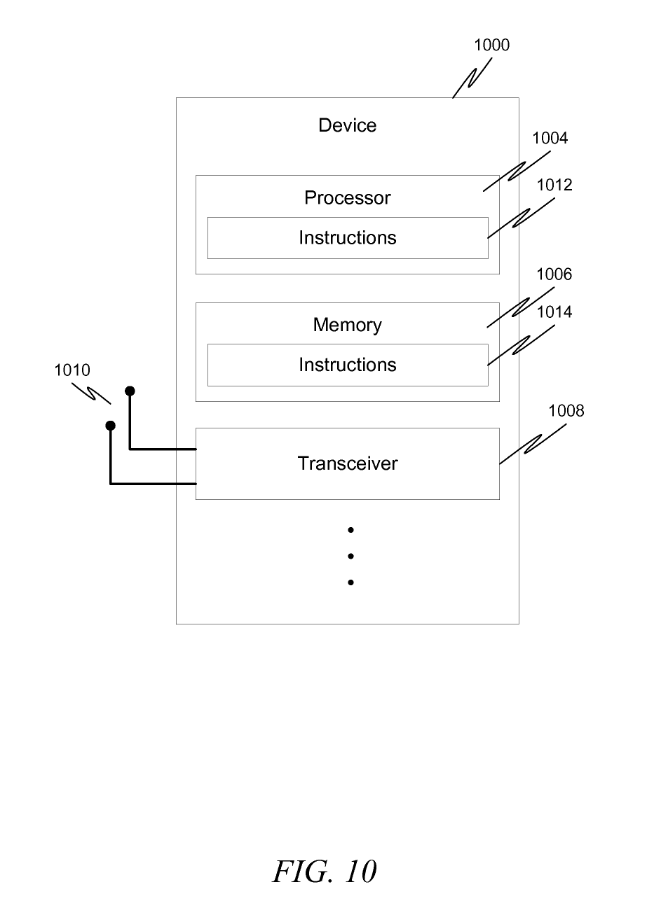

FIG. 10 illustrates a system block diagram of a wireless device 1000, according to some embodiments. Such a wireless device 1000 can represent, for example, an AP and/or other device (e.g., STA) as described in conjunction with FIGS. 1-9 above. The procedures, message exchanges, and so forth described above are suitable for implementation on the illustrated device 1000.

The device 1000 may include a processor 1004, a memory 1006, a transceiver 1008, antennas 1010, instructions 1012, 1014, and possibly other components (not shown).

The processor 1004 comprises one or more central processing units (CPUs), graphics processing units (GPUs), accelerated processing units (APUs), signal processors, or various combinations thereof. The processor 1004 provides processing and control functionalities for the device 1000 and may implement the flow diagrams and logic described above for the AP and devices of FIGS., 1-9.

The memory 1006 comprises one or more transient and/or static memory units configured to store instructions 1012, 1014 and data for the device 1000. The transceiver 1008 comprises one or more transceivers including, for an appropriate station or responder, a multiple-input and multiple-output (MIMO) antenna to support MIMO communications. For the device 1000, the transceiver 1008 receives transmissions and transmits transmissions. The transceiver circuitry also measures the signal level, the noise ratio, or other metrics that are used by the device to calculate SNR, SNIR, or other signal measurements for use in the embodiments described herein. For example, the transceiver circuitry can comprise a correlation receiver that correlates headers in received packets in order to detect incoming signals. Such a correlation receiver can detect the energy in received packets (e.g., received signal level). The transceiver circuitry can also measure noise and/or interference levels in known fashions for calculation of SNR and/or SNIR.

The transceiver 1008 may be coupled to the antennas 1010, which represent an antenna or multiple antennas, as appropriate to the device 1000. The AP and devices may operate with multiple frequencies to transmit and receive on multiple frequency slots as described above.

The instructions 1012, 1014 comprise one or more sets of instructions or firmware/software executed on a computing device (or machine) to cause such a computing device (or machine) to perform any of the methodologies discussed herein. The instructions 1012, 1014 (also referred to as computer- or machine-executable instructions) may reside, completely or at least partially, within the processor 1004 and/or the memory 1006 during execution thereof by the device 1000. While the instructions 1012 and 1014 are illustrated as separate, they can be part of the same whole. The processor 1004 and the memory 1006 also comprise machine-readable storage media. The instructions 1012 and 1014 may implement, for example, all or part of the flow associated with FIGS. 5-7 or other described operations attributed to the AP and/or the devices. Additionally, or alternatively, the instructions 1012 and 1014 may implement other processing and functionality discussed in conjunction with the other embodiments above.

### Processing Circuitry

In FIG. 10, processing and control functionalities are illustrated as being provided by the processor 1004 along with the associated instructions 1012 and 1014. However, these are only examples of processing circuitry that comprise programmable logic or circuitry (e.g., as encompassed within a general-purpose processor 1004 or other programmable processor) that is temporarily configured by software or firmware to perform certain operations. In various embodiments, processing circuitry may comprise dedicated circuitry or logic that is permanently configured (e.g., within a special-purpose processor, application specific integrated circuit (ASIC), or array) to perform certain operations. It will be appreciated that a decision to implement processing circuitry mechanically, in dedicated and permanently configured circuitry, or in temporarily configured circuitry (e.g., configured by software) may be driven by cost, time, energy-usage, package size, or other considerations.

Accordingly, the term “processing circuitry” should be understood to encompass a tangible entity, be that an entity that is physically constructed, permanently configured (e.g., hardwired), or temporarily configured (e.g., programmed) to operate in a certain manner or to perform certain operations described herein.

### Machine-Readable Medium

The instructions 1012, 1014 are illustrated as being stored on memory 1006 and/or in processor 1004. While the memory 1006 and/or processor 1004 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks. The term machine-readable medium specifically excludes non-statutory signals per se.

### Transmission Medium

The instructions 1012/1014 may further be transmitted or received such as by transceiver circuitry 1008 and/or antennas 1010 using a transmission medium. The instructions 1012/1014 may be transmitted using any one of a number of well-known transfer protocols. Transmission medium encompasses mechanisms by which the instructions 1012/1014 are transmitted, such as communication networks. The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The following represent example embodiments:

### Example 1

An access point comprising hardware processing circuitry configured to:

receive a message from a station;

evaluate a signal measurement for the message;

compare the signal measurement to a signal threshold, above which aggregation will not be considered;

responsive to the signal measurement being above the threshold, send a first message to the station clearing the station to transmit using a full bandwidth; and

responsive to the signal measurement being equal to or less than the threshold, send a second message to a plurality of stations to aggregate at least one additional station with the station, the message clearing the aggregated stations to transmit during the same time period, each on a different frequency slot occupying a portion of the full bandwidth.

### Example 2

The method of example 1, wherein responsive to the signal measurement being equal to or less than the threshold, the hardware processing circuitry is configured to:

select stations with an associated signal measurement that is less than or equal to the signal threshold, the selected stations forming a first group;

select a subset of stations to aggregate from the first group;

allocate at least one frequency slot to at least a portion of the subset; and

send the second message to the subset of the first group.

### Example 3

The device of example 2, wherein the subset is selected by configuring the processing circuitry to select first n stations with the lowest associated signal measurement, where n is calculated by dividing available bandwidth for transmission by a minimum frequency unit.

### Example 4

The device of example 2, wherein the subset is selected by configuring the processing circuitry to:

divide the first group into a plurality of ranges based on the signal measurement associated with each station in the first group; and

select at least one station from at least some of the plurality of ranges to form the subset.

### Example 5

The device of example 2, 3, or 4, wherein the subset is selected so that the difference in the highest associated signal measurement and lowest associated signal measurement is less than a threshold.

### Example 6

The device of example 2, wherein the subset is selected by configuring the processing circuitry to:

divide first group into a plurality of ranges based on the signal measurement associated with each station in the first group; and
select at least one of the plurality of ranges to form the subset.

### Example 7

The device of example 2, wherein the signal measurement threshold is between about 20 dB and about 30 dB.

### Example 8

The device of example 2, wherein the frequency slots are allocated by configuring the processing circuitry to:

choose whether to start at the station from the subset with the highest or lowest associated signal measurement as a starting station; and

assign frequency slots beginning with the starting station and continuing until all stations of the subset are assigned frequency slots.

### Example 9

The device of examples 2, 3, 4, 5, 6, 7, or 8, wherein the processing circuitry is further configured to assign multiple frequency slots to stations having a number of packets to transmit that exceeds a single time slot.

### Example 10

A method performed by an access point (AP) comprising:

receiving a message from a station;

evaluating signal-to-noise (SNR) ratio for the message;

comparing the SNR to a SNR threshold, above which aggregation will not be considered;

responsive to the SNR being above the threshold, sending a message to the station clearing the station to transmit; and

responsive to the SNR being equal to or less than the threshold, aggregating at least one additional station with the station so that the aggregated stations transmit during the same time period.

### Example 11

The method of example 10, wherein the aggregation comprises:

selecting stations with an associated SNR measurement that is less than or equal to the SNR threshold, the selected stations forming a first group;

selecting a subset of stations to aggregate from the first group using a selection method;

allocating at least one frequency slot to at least a portion of the subset using a frequency slot allocation method; and

scheduling uplink for the subset of the first group.

### Example 12

The method of example 11, wherein the selection method comprises selecting the first n stations with the lowest associated SNR, where n is calculated by dividing available bandwidth for transmission by a minimum frequency unit.

### Example 13

The method of example 11, wherein the selection method comprises:

dividing first group into a plurality of ranges; and

selecting at least one station from at least some of the plurality of ranges to form the subset.

### Example 14

The method of example 11, wherein the selection method comprises:

dividing first group into a plurality of ranges; and
selecting at least one of the plurality of ranges to form the subset.

### Example 15

A machine readable medium having executable instructions embodied thereon that, when executed, configure a device to:

identify a SNR threshold above which aggregation will not be considered;

identify a plurality of stations, each station having an associated SNR measurement;

eliminate all stations from the plurality of stations which have an associated SNR measurement larger than the SNR threshold, the remaining stations forming a first group;

select a subset of stations to aggregate from the first group based on the associated SNR of each station in the first group and the number of stations in the first group;

allocate at least one frequency slot to at least a portion of the subset; and

schedule uplink for the stations in the subset.

### Example 16

The machine readable medium of example 15, wherein the subset is selected by selecting first n stations with the lowest associated SNR, where n is calculated by dividing available bandwidth for transmission by a minimum frequency unit.

### Example 17

The machine readable medium of example 15, wherein the subset is selected by:

dividing first group into a plurality of ranges; and

selecting at least one station from at least some of the plurality of ranges to form the subset.

### Example 18

The machine readable medium of example 17, wherein the subset is selected by:
dividing first group into a plurality of ranges; and
selecting at least one of the plurality of ranges to form the subset.

### Example 19

A device comprising:

at least one antenna;

transceiver circuitry coupled to the at least one antenna;

memory;

a processor coupled to the memory and transceiver circuitry; and

instructions, stored in the memory, which when executed cause the processor to:

identify a signal threshold above which aggregation will not be considered;

identify a plurality of stations, each station having an associated signal measurement;

eliminate all stations from the plurality of stations which have an associated signal measurement larger than the signal threshold, the remaining stations forming a first group;

select a subset of stations to aggregate from the first group based on the associated signal measurement of each station in the first group and the number of stations in the first group;

allocate at least one frequency slot to at least a portion of the subset; and

schedule uplink for the stations in the subset.

### Example 20

The device of example 19, wherein the signal threshold is between about 20 dB and about 30 dB.

What is claimed is:

1. An access point comprising hardware processing circuitry configured to:
receive a message from a station;
evaluate a signal measurement for the message;
compare the signal measurement to a signal threshold, above which aggregation will not be considered;
responsive to the signal measurement being above the threshold, send a first message to the station clearing the station to transmit using a full bandwidth; and
responsive to the signal measurement being equal to or less than the threshold, send a second message to a plurality of stations to aggregate at least one additional station with the station, the message clearing the aggregated stations to transmit during the same time period, each on a different frequency slot occupying a portion of the full bandwidth.

2. The method of claim 1, wherein responsive to the signal measurement being equal to or less than the threshold, the hardware processing circuitry is configured to:
select stations with an associated signal measurement that is less than or equal to the signal threshold, the selected stations forming a first group;
select a subset of stations to aggregate from the first group;
allocate at least one frequency slot to at least a portion of the subset; and
send the second message to the subset of the first group.

3. The device of claim 2, wherein the subset is selected by configuring the processing circuitry to select first n stations with the lowest associated signal measurement, where n is calculated by dividing available bandwidth for transmission by a minimum frequency unit.

4. The device of claim 2, wherein the subset is selected by configuring the processing circuitry to:
divide the first group into a plurality of ranges based on the signal measurement associated with each station in the first group; and
select at least one station from at least some of the plurality of ranges to form the subset.

5. The device of claim 4, wherein the subset is selected so that the difference in the highest associated signal measurement and lowest associated signal measurement is less than a threshold.

6. The device of claim 2, wherein the subset is selected by configuring the processing circuitry to:
divide first group into a plurality of ranges based on the signal measurement associated with each station in the first group; and
select at least one of the plurality of ranges to form the subset.

7. The device of claim 2, wherein the signal threshold is between about 20 dB and about 30 dB.

8. The device of claim 2, wherein the frequency slots are allocated by configuring the processing circuitry to:
choose whether to start at the station from the subset with the highest or lowest associated signal measurement as a starting station; and
assign frequency slots beginning with the starting station and continuing until all stations of the subset are assigned frequency slots.

9. The device of claim 8, wherein the processing circuitry is further configured to assign multiple frequency slots to stations having a number of packets to transmit that exceeds a single time slot.

10. A method performed by an access point (AP) comprising:
receiving a message from a station;
evaluating signal-to-noise (SNR) ratio for the message;
comparing the SNR to a SNR threshold, above which aggregation will not be considered;
responsive to the SNR being above the threshold, sending a message to the station clearing the station to transmit; and
responsive to the SNR being equal to or less than the threshold, aggregating at least one additional station with the station so that the aggregated stations transmit during the same time period.

11. The method of claim 10, wherein the aggregation comprises:
selecting stations with an associated SNR measurement that is less than or equal to the SNR threshold, the selected stations forming a first group;
selecting a subset of stations to aggregate from the first group using a selection method;
allocating at least one frequency slot to at least a portion of the subset using a frequency slot allocation method; and
scheduling uplink for the subset of the first group.

12. The method of claim 11, wherein the selection method comprises selecting the first n stations with the lowest associated SNR, where n is calculated by dividing available bandwidth for transmission by a minimum frequency unit.

13. The method of claim 11, wherein the selection method comprises:
dividing first group into a plurality of ranges; and
selecting at least one station from at least some of the plurality of ranges to form the subset.

14. The method of claim 11, wherein the selection method comprises:
dividing first group into a plurality of ranges; and
selecting at least one of the plurality of ranges to form the subset.

15. A machine readable medium having executable instructions embodied thereon that, when executed, configure a device to:
identify a SNR threshold above which aggregation will not be considered;
identify a plurality of stations, each station having an associated SNR measurement;
eliminate all stations from the plurality of stations which have an associated SNR measurement larger than the SNR threshold, the remaining stations forming a first group;
select a subset of stations to aggregate from the first group based on the associated SNR of each station in the first group and the number of stations in the first group;
allocate at least one frequency slot to at least a portion of the subset; and
schedule uplink for the stations in the subset.

16. The machine readable medium of claim 15, wherein the subset is selected by selecting first n stations with the lowest associated SNR, where n is calculated by dividing available bandwidth for transmission by a minimum frequency unit.

17. The machine readable medium of claim 15, wherein the subset is selected by:
dividing first group into a plurality of ranges; and
selecting at least one station from at least some of the plurality of ranges to form the subset.

18. The machine readable medium of claim 17, wherein the subset is selected by:
dividing first group into a plurality of ranges; and
selecting at least one of the plurality of ranges to form the subset.

19. A device comprising:
at least one antenna;
transceiver circuitry coupled to the at least one antenna;
memory;
a processor coupled to the memory and transceiver circuitry; and
instructions, stored in the memory, which when executed cause the processor to:
identify a signal threshold above which aggregation will not be considered;
identify a plurality of stations, each station having an associated signal measurement;
eliminate all stations from the plurality of stations which have an associated signal measurement larger than the signal threshold, the remaining stations forming a first group;
select a subset of stations to aggregate from the first group based on the associated signal measurement of each station in the first group and the number of stations in the first group;
allocate at least one frequency slot to at least a portion of the subset; and
schedule uplink for the stations in the subset.

20. The device of claim 19, wherein the signal threshold is between about 20 dB and about 30 dB.
